(19) United States
(12) Patent Application Publication
(10) Pub. No.: US 2018/0007071 A1
(43) Pub. Date: Jan. 4, 2018

(54) COLLABORATIVE INVESTIGATION OF SECURITY INDICATORS

(71) Applicant: HEWLETT PACKARD ENTERPRISE DEVELOPMENT LP, Houston, TX (US)

(72) Inventors: Tomas Sander, Princeton, NJ (US); Brian Hein, Aliso Viejo, CA (US); Ted Ross, Austin, TX (US)

(21) Appl. No.: 15/545,099

(22) PCT Filed: Jan. 30, 2015
(86) PCT No.: PCT/US2015/013885

§ 371 Date: Jul. 20, 2017

(51) Int. Cl. H04L 29/06

(52) U.S. Cl. CPC H04L 63/1416; H04L 63/1441; H04L 63/101; H04L 63/1433

(57) ABSTRACT

Examples relate to collaborative investigation of security indicators. The examples disclosed herein enable presenting, via a user interface, community-based threat information associated with a security indicator to a user. The community-based threat information may comprise investigation results that are obtained from a community of users for the security indicator, and an indicator score that is determined based on the investigation results. The examples further enable obtaining an investigation result from the user and updating the indicator score based on the investigation result.

### BACKGROUND

A blacklist may comprise a plurality of security indicators (e.g., a list of IP addresses, domain names, e-mail addresses, Uniform Resource Locators (URLs), software file hashes, etc.). For example, the blacklist may be used to block, filter out, and/or deny access to certain resources by an event that matches at least one of the plurality of security indicators and/or to generate a security alert when the match is detected.

### BRIEF DESCRIPTION OF THE DRAWINGS

The following detailed description references the drawings, wherein:

FIG. 1 is a block diagram depicting an example environment in which various examples may be implemented as a collaborative investigation system.

FIG. 2 is a block diagram depicting an example collaborative investigation system.

FIG. 3 is a block diagram depicting an example machine-readable storage medium comprising instructions executable by a processor for collaborative investigation of security indicators.

FIG. 4 is a block diagram depicting an example machine-readable storage medium comprising instructions executable by a processor for collaborative investigation of security indicators.

FIG. 5 is a flow diagram depicting an example method for collaborative investigation of security indicators.

FIG. 6 is a flow diagram depicting an example method for collaborative investigation of security indicators.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Users of a security information sharing platform typically share security indicators, security alerts, and/or other security-related information (e.g., mitigations strategies, attackers, attack campaigns and trends, threat intelligence information, etc.) with other users in an effort to advise the other users of any security threats, or to gain information related to security threats from other users. The other users with whom the security information is shared typically belong to a community that is selected by the user for sharing, or to the same community as the user. The other users of such communities may further share the security information with further users and/or communities. A “user,” as used herein, may include an individual, organization, or any entity that may send, receive, and/or share the security information. A community may include a plurality of users. For example, a community may include a plurality of individuals in a particular area of interest. A community may include a global community where any user may join, for example, via subscription. A community may also be a vertical-based community. For example, a vertical-based community may be a healthcare or a financial community. A community may also be a private community with a limited number of selected users.

A “blacklist,” as used herein, may comprise a plurality of security indicators (e.g., a list of IP addresses, domain names, e-mail addresses, Uniform Resource Locators (URLs), software file hashes, etc.). For example, the blacklist may be used to block, filter out, and/or deny access to certain resources by an event that matches at least one of the plurality of security indicators and/or to generate a security alert when the match is detected. A “security alert,” as used herein, may refer to an indication, a notification, and/or a message that at least one security indicator is detected in event data. “Event data,” as used herein, may comprise information related to events occurring in network, servers, applications, databases, and/or various components of any computer system. For example, the event data may include network traffic data such as IP addresses, e-mail addresses, Uniform Resource Locators (URLs), software files, etc.

In some instances, a blacklist may include security indicators that have been erroneously classified as malicious. In other words, some of the security indicators of the blacklist may be false-positives. For example, if a popular news site that is actually benign and not malicious ends up on the blacklist, the site would be blocked, causing inconvenience to the users and/or communities. Moreover, this may cause erroneous security alerts to be generated, contaminating the data being shared and continuously being re-shared in the security information sharing environment.

A high number of false-positive indicators (e.g., indicators that are false-positive) in a blacklist can prevent security analysts (e.g., security operations center (SOC) analysts) from timely investigating those false-positive indicators and/or removing such indicators from the blacklist. Further, the results of the investigation can be skewed based on the level of knowledge and skills of a limited number of the security analysts.

Examples disclosed herein provide technical solutions to these technical challenges by distributing the workload for the investigation across a community of the security information sharing platform while utilizing the knowledge and skills of various users of the platform effectively reducing the number of false-positive security indicators. The examples disclosed herein enable presenting, via a user interface, community-based threat information associated with a security indicator to a user. The community-based threat information may comprise investigation results that are obtained from a community of users for the security indicator, and an indicator score that is determined based on the investigation results. The examples further enable obtaining an investigation result from the user, the investigation result and updating the indicator score based on the investigation result.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

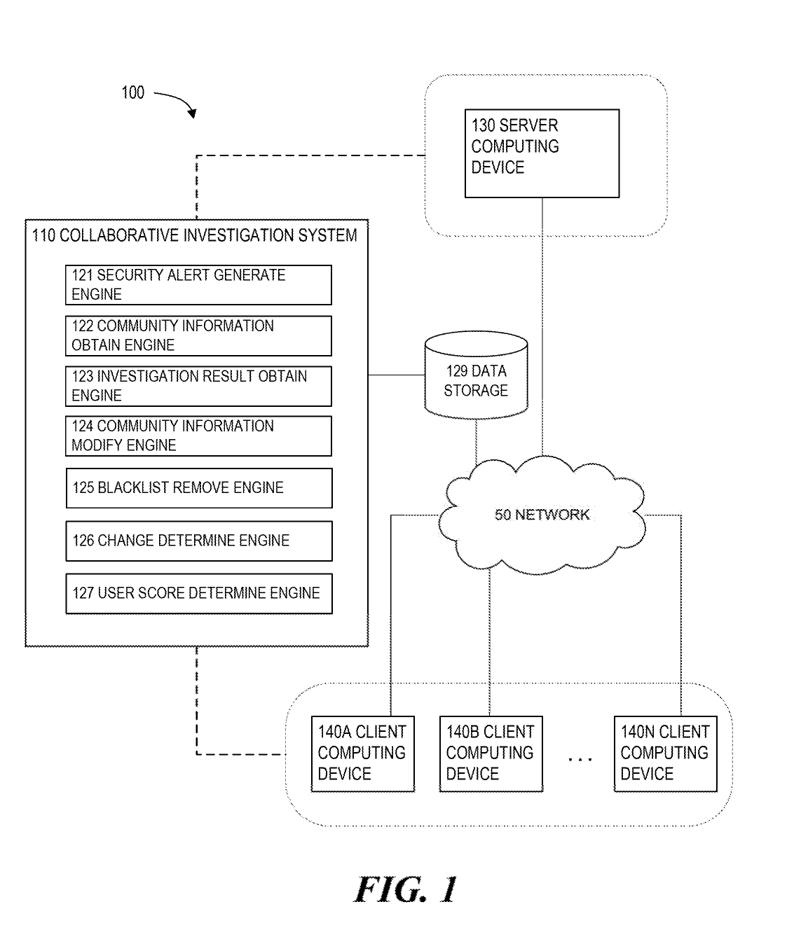

FIG. 1 is an example environment 100 in which various examples may be implemented as a collaborative investigation system 110. Environment 100 may include various components including server computing device 130 and client computing devices 140 (illustrated as 140A, 140B, . . . , 140N). Each client computing device 140A, 140B, . . . , 140N may communicate requests to and/or receive responses from server computing device 130. Server computing device 130 may receive and/or respond to requests from client computing devices 140. Client computing devices 140 may be any type of computing device providing a user interface through which a user can interact with a software application. For example, client computing devices 140 may include a laptop computing device, a desktop computing device, an all-in-one computing device, a tablet computing device, a mobile phone, an electronic book reader, a network-enabled appliance such as a “Smart” television, and/or other electronic device suitable for displaying a user interface and processing user interactions with the displayed interface. While server computing device 130 is depicted as a single computing device, server computing device 130 may include any number of integrated or distributed computing devices serving at least one software application for consumption by client computing devices 140.

The various components (e.g., components 129, 130, and/or 140) depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, collaborative investigation system 110 and the various components described herein may be implemented in hardware and/or a combination of hardware and programming that configures hardware. Furthermore, in FIG. 1 and other Figures described herein, different numbers of components or entities than depicted may be used.

Collaborative investigation system 110 may comprise a security alert generate engine 121, a community information obtain engine 122, an investigation result obtain engine 123, a community information modify engine 124, a blacklist remove engine 125, a change determine engine 126, a user score determine engine 127, and/or other engines. The term “engine”, as used herein, refers to a combination of hardware and programming that performs a designated function. As is illustrated respect to FIGS, 3-4, the hardware of each engine, for example, may include one or both of a processor and a machine-readable storage medium, while the programming is instructions or code stored on the machine-readable storage medium and executable by the processor to perform the designated function,

Security alert generate engine 121 may generate a security alert based on a detection of at least one security indicator in event data. Note that a “blacklist,” as used herein, may comprise a plurality of security indicators (e.g., a list of IP addresses, domain names, e-mail addresses, Uniform Resource Locators (URLs), software file hashes, etc.). For example, the blacklist may be used to block, filter out, and/or deny access to certain resources by an event that matches at least one of the plurality of security indicators and/or to generate a security alert when the match is detected. As such, a “security alert,” as used herein, may refer to an indication, a notification, and/or a message that at least one security indicator is detected in event data. “Event data,” as used herein, may comprise information related to events occurring in network, servers, applications, databases, and/or various components of any computer system. For example, the event data may include network traffic data such as IP addresses, e-mail addresses, Uniform Resource Locators (URLs), software files, etc. In some implementations, the event data may be stored in at least one log file (e.g., system and/or security logs).

The plurality of security indicators in the blacklist may be originated from at least one of a plurality of sources. For example, the security indicators may be manually created and/or added to the blacklist by a user (e.g., system administrator). In another example, the blacklist may include threat intelligence feeds from various intelligence providers. There exist a number of providers of threat intelligence feeds, both open source and paid or closed source. The threat intelligence feeds may be provided by independent third parties such as security service providers. These providers and/or sources may supply the threat intelligence information that provide information about threats the providers have identified. Most threat intelligence feeds, for example, include lists of domain names, IP addresses, and URLs that various providers have classified as malicious or at least suspicious according to different methods and criteria. The blacklist may be stored in a data storage (e.g., data storage 129). The security indicators in the blacklist may be added, removed, or otherwise modified.

Community information obtain engine 122 may obtain community-based threat information associated with a security indicator of the blacklist. “Community-based threat information,” as used herein, may comprise a plurality of investigation results obtained from a plurality of users, an indicator score, information related to the plurality of users (e.g., user identification, user scores, etc.), information related to the security indicator (e.g., an investigation status of the security indicator, a source of the security indicator, a level of severity, importance, priority, and confidence of the security indicator, historical sightings of the security indicator, etc.), and/or other information. In some implementations, the blacklist may be shared with various users of a community or communities such that the users may collaboratively investigate individual security indicators of the blacklist using the community-based threat information associated with the individual security indicators.

An investigation result obtained from a particular user may indicate whether the security indicator is malicious (or has been misclassified as malicious and therefore is a false-positive). When a new investigation result is obtained, the community-based threat information may be modified such that the plurality of investigation results includes the new investigation result.

The indicator score may be determined based on at least one parameter. A single parameter and/or a combination of multiple parameters may be used to determine the indicator score. The indicator score may indicate a level of confidence that the security indicator is actually malicious in view of the collective knowledge drawn from the plurality of investigation results. The at least one parameter may comprise the number of the investigation results in the plurality of investigation results that indicate that the security indicator is malicious, the total number of the plurality of investigation results, the information related to the plurality of users, the information related to the security indicator, and/or other parameters. For example, the indicator score may be determined based on a percentage of the number of the investigation results indicating that the security indicator is malicious in the total number of the plurality of investigation results. The higher the percentage, the higher the indicator score will be. In another example, the indicator score may be determined based on the user scores (e.g., reputation scores associated with individual users). In this example, the investigation result of a first user with a higher user score may be weighted higher than the investigation result of a second user with a lower user score when determining the indicator score. How the user scores are determined is discussed herein with respect to user score determine engine 127.

In some implementations, community information obtain engine 122 may obtain the community-based threat information from a data storage (e.g., data storage 129).

In some implementations, community information obtain engine 122 may present, via user interface, the community-based threat information to a user. In this way, the user can review the community-based threat information to understand the contextual information about the security indicator before determining whether the security indicator is malicious. For example, the user may review at least one investigation result obtained from another user. The user may choose to review the investigation results obtained from the users with higher user reputation scores than other users. In another example, the information related to the security indicator may inform the user that the security indicator has a high level of priority that requires immediate attention. In another example, when the total number of investigation results that have been obtained is low, the user may feel inclined to investigate the particular security indicator.

Investigation result obtain engine 123 may obtain a new investigation result from the user. The new investigation result may indicate whether the security indicator is malicious (or has been misclassified as malicious and therefore is a false-positive). The new investigation result may further include a comment (e.g., a reason that the security indicator is malicious or not malicious) and/or supporting evidence (e,g., attachments) obtained from the user. The new investigation result may be included in the community-based threat information and/or may be used to update the community-based threat information, which is discussed herein with respect to community information modify engine 124.

When the user is ready to investigate the security indicator, the user may indicate, via the user interface, that the security indicator is under the investigation by the user (e.g., by clicking on a graphical user interface (GUI) object). Investigation result obtain engine 123 may receive, via the user interface, the indication that the security indicator is under investigation by the user. In one example, the investigation status may be updated and/or modified (e.g., by community information modify engine 124) based on that indication such that community-based threat information shows that the security indicator is under investigation by the particular user. When the user submits the new investigation result, the investigation status may be updated and/or modified (e.g., by community information modify engine 124) to reflect that the investigation by the user has been completed. In this example, the investigation status may be time-.stamped with a start time and/or an end time of the investigation.

Community information modify engine 124 may modify (and/or update) the community-based threat information based on the new investigation result. For example, the plurality of investigation results of the community-based threat information may include the new investigation result. The information related to the plurality of users (e.g., user identification, user scores, etc.) may be updated to include the information about the user from whom the new investigation result has been obtained.

Community information modify engine 124 may modify the indicator score based on the new investigation result. The indicator score may be determined, as discussed herein with respect to community information obtain engine 122, based on at least one parameter (e.g., the number of the investigation results in the plurality of investigation results that indicate that the security indicator is malicious, the total number of the plurality of investigation results, the information related to the plurality of users, the information related to the security indicator, and/or other parameters). When the new investigation result is obtained, the determined indicator score may be re-determined, adjusted, updated, or otherwise modified in view of the new investigation result. The values of the at least one parameter may be updated as the community-based threat information is updated based on the new investigation result. For example, the total number of the plurality of investigation results may be increased by one. The number of the investigation results in the plurality of investigation results that indicate the security indicator is malicious may also be increased by one if the user determined, in the new investigation result, that the security indicator is malicious. The user score of the user of the new investigation result may influence the indicator score.

Blacklist remove engine 125 may determine whether to remove the security indicator from the blacklist based on the indicator score. In doing so, blacklist remove engine 125 may compare the indicator score with a threshold. For example, the indicator score may represent the percentage of the number of the investigation results indicating that the security indicator is malicious in the total number of the plurality of investigation results. If 3 out of 10 users have indicated that the security indicator is malicious, then the indicator score may be 0.3, for example. The threshold may be predetermined to be 0.5. Since the indicator score (e.g., 0.3) is below the threshold value (e.g., 0.5), blacklist remove engine 125 may exclude the security indicator from the blacklist based on this comparison. On the other hand, the security indicator may remain in the blacklist if the indicator score exceeds (or equal to) the threshold value.

In some implementations, blacklist remove engine 125 may compare the total number of the investigation results in the plurality of investigation results with another predetermined threshold prior to determining whether to remove the security indicator from the blacklist. This is to ensure that the determination of the removal is made based on a sufficient number of investigation results. For example, at least 20 investigation results may be required to make the determination about whether to remove the security indicator. Returning to the example above, 7 out of 10 total investigation results indicate that the security indicator malicious, resulting the indicator score of 0.7, which is above the threshold value of 0.5. However, the security indicator may still remain in the blacklist because the total number of investigation results (e.g., 10) is still less than the threshold value of 20 required results.

Change determine engine 126 may determine whether a change to the community-based threat information occurs. In response to determining that the change to the community-based threat information occurs, change determine engine 126 may generate a notification that informs at least one of the plurality of users (e.g., the user who submitted the new investigation result or any other user related to the particular security indicator) of the change. For example, when another new investigation result has been submitted by another user regarding the same security indicator, at least one of the plurality of users may be notified of this new investigation result, its details, and/or the modified and/or updated community-based threat information (e.g., the modified indicator score). In another example, if the investigation of the security indicator has been completed, closed, and/or resolved, at least one of the plurality of users may be notified accordingly.

User score determine engine 127 may determine a user score associated with the user based on at least one of: user qualifications (e.g., skills, experience, education, etc.), at least one investigation result that the user has previously submitted (e.g., ratings on the user's past investigation results provided by other users, timing of the past investigation result submissions, the number of the past submissions, the frequency of the past submissions, etc.), and/or other user-related parameters. As discussed herein with respect to community information obtain engine 122, the user score may be used to determine and/or influence the indicator score.

In performing their respective functions, engines 121-127 may access data storage 129 and/or other suitable database(s). Data storage 129 may represent any memory accessible to collaborative investigation system 110 that can be used to store and retrieve data. Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. Collaborative investigation system 110 may access data storage 129 locally or remotely via network 50 or other networks.

Data storage 129 may include a database to organize and store data, Database 129 may be, include, or interface to, for example, an Oracle™ relational database sold commercially by Oracle Corporation. Other databases, such as Informix™, DB2 (Database 2) or other data storage, including file-based (e.g., comma or tab separated files), or query formats, platforms, or resources such as OLAP (On Line Analytical Processing), SQL (Structured Query Language), a SAN (storage area network), Microsoft Access™, MySQL, PostgreSQL, HSpace, Apache Cassandra, MongoDB, Apache CouchDB™, or others may also be used, incorporated, or accessed. The database may reside in a single or multiple physical device(s) and in a single or multiple physical location(s). The database may store a plurality of types of data and/or files and associated data or file description, administrative information, or any other data.

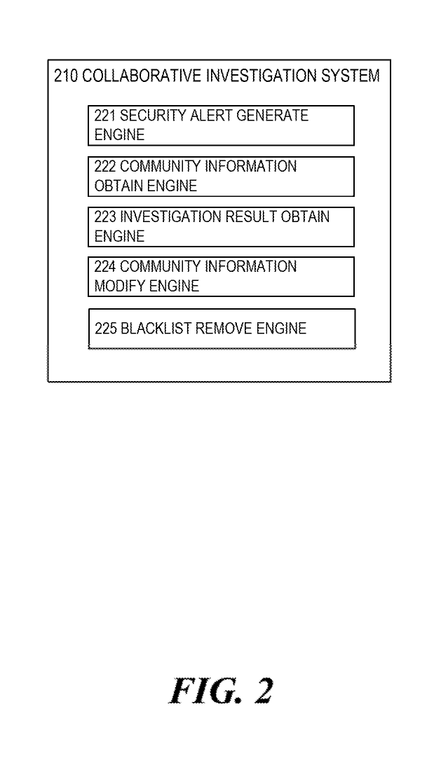

FIG. 2 is a block diagram depicting an example collaborative investigation system 210. Collaborative investigation system 210 may comprise a security alert generate engine 221, a community information obtain engine 222, an investigation result obtain engine 223, a community information modify engine 224, a blacklist remove engine 225, and/or other engines. Engines 221-225 represent engines 121-125, respectively,

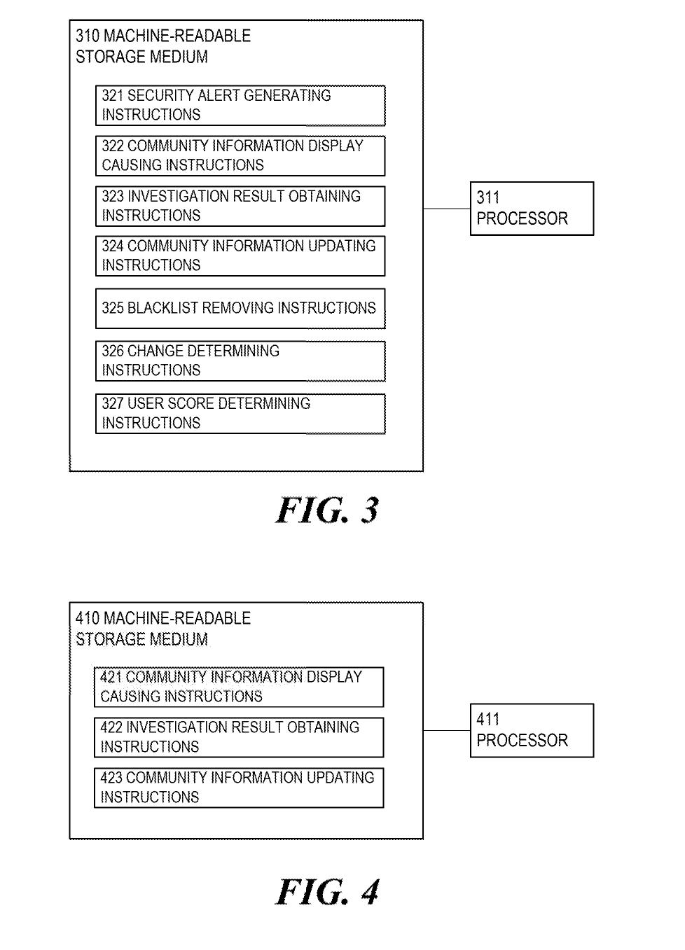

FIG. 3 is a block diagram depicting an example machine-readable storage medium 310 comprising instructions executable by a processor for collaborative investigation of security indicators.

In the foregoing discussion, engines 121-127 were described as combinations of hardware and programming. Engines 121-127 may be implemented in a number of fashions. Referring to FIG. 3, the programming may be processor executable instructions 321-327 stored on a machine-readable storage medium 310 and the hardware may include a processor 311 for executing those instructions, Thus, machine-readable storage medium 310 can be said to store program instructions or code that when executed by processor 311 implements collaborative investigation system 110 of FIG. 1.

In FIG. 3, the executable program instructions in machine-readable storage medium 310 are depicted as security alert generating instructions 321, community information display causing instructions 322, investigation result obtaining instructions 323, community information updating instructions 324, blacklist removing instructions 325, change determining instructions 326, and user score determining instructions 327. Instructions 321-327 represent program instructions that, when executed, cause processor 311 to implement engines 121-127, respectively.

FIG, 4 is a block diagram depicting an example machine-readable storage medium 410 comprising instructions executable by a processor for collaborative investigation of security indicators.

In the foregoing discussion, engines 121-127 were described as combinations of hardware and programming. Engines 121-127 may be implemented in a number of fashions. Referring to FIG. 4, the programming may be processor executable instructions 421-423 stored on a machine-readable storage medium 410 and the hardware may include a processor 411 for executing those instructions. Thus, machine-readable storage medium 410 can be said to store program instructions or code that when executed by processor 411 implements collaborative investigation system 110 of FIG. 1.

In FIG. 4, the executable program instructions in machine-readable storage medium 410 are depicted as community information display causing instructions 421, investigation result obtaining instructions 422, and community information updating instructions 423. Instructions 421-423 represent program instructions that, when executed, cause processor 411 to implement engines 122-124, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices. Further, machine-readable storage medium 310 (or machine-readable storage medium 410) may be fully or partially integrated in the same device as processor 311 (or processor 411), or it may be separate but accessible to that device and processor 311 (or processor 411).

In one example, the program instructions may be part of an installation package that when installed, can be executed by processor 311 (or processor 411) to implement collaborative investigation system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321-327, and/or other instructions. As an alternative or in addition to retrieving and executing instructions, processor 311 may include at least one electronic circuit comprising a number of electronic components for performing the functionality of at least one of instructions 321-327, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-423, and/or other instructions. As an alternative or in addition to retrieving and executing instructions, processor 411 may include at least one electronic circuit comprising a number of electronic components for performing the functionality of at least one of instructions 421-423, and/or other instructions.

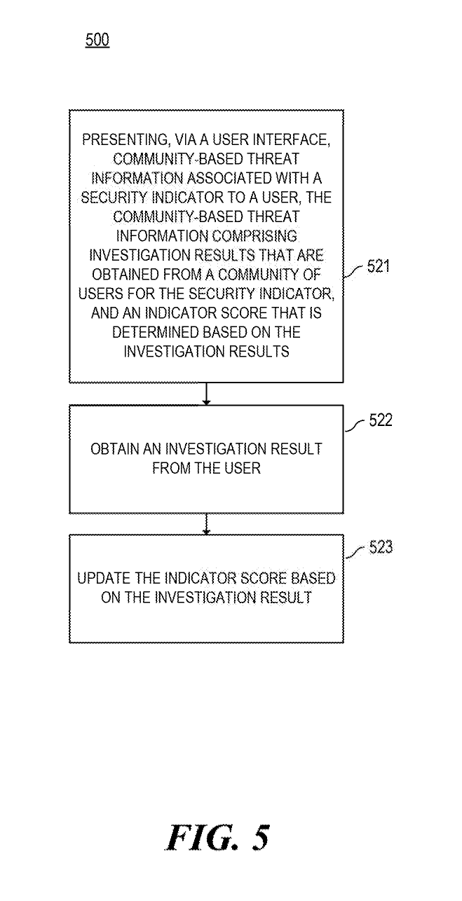

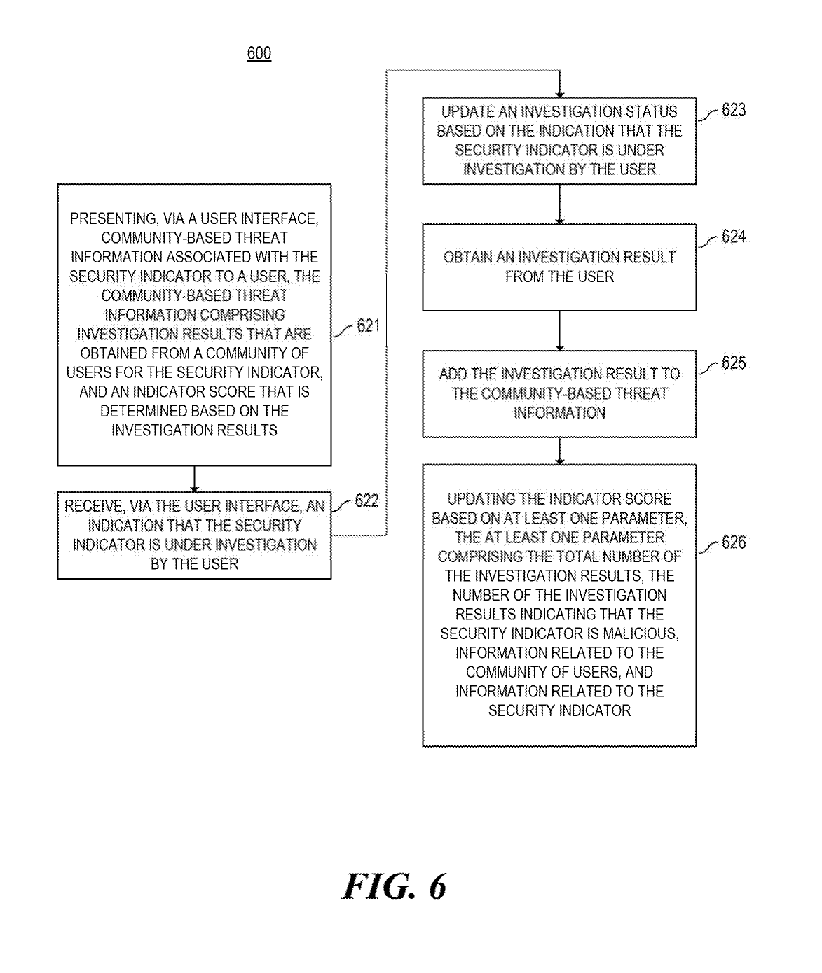

FIG. 5 is a flow diagram depicting an example method 500 for obtaining content determined based on an event that is generated by an external transactional system. The various processing blocks and/or data flows depicted in FIG. 5 (and in the other drawing figures such as FIG. 6) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant be an example, and, as such, should not be viewed as limiting. Method 500 may be implemented in the form of executable instructions stored on a machine-readable storage medium, such as storage medium 310, and/or in the form of electronic circuitry.

Method 500 may start in block 521 where community-based threat information associated with a security indicator is presented to a user via a user interface. Note that a “blacklist,” as used herein, may comprise a plurality of security indicators (e.g., a list of IP addresses, domain names, e-mail addresses, Uniform Resource Locators (URLs), software file hashes, etc.). For example, the blacklist may be used to block, filter out, and/or deny access to certain resources by an event that matches at least one of the plurality of security indicators and/or to generate a security alert when the match is detected. In some implementations, the blacklist may be shared with various users of a community or communities such that the users may collaboratively investigate individual security indicators of the blacklist using the community-based threat information associated with the individual security indicators.

The community-based threat information may comprise investigation results that are obtained from a community of users for the security indicator, an indicator score that is determined based on the investigation results, information related to the plurality of users (e.g., user identification, user scores, etc.), information related to the security indicator (e.g., an investigation status of the security indicator, a source of the security indicator, a level of severity, importance, priority, and confidence of the security indicator, historical sightings of the security indicator, etc.), and/or other information. The user can review the community-based threat information via the user interface to understand the contextual information about the security indicator before determining whether the security indicator is malicious (or has been misclassified as malicious and therefore is a false-positive). For example, the user may review at least one investigation result obtained from another user. The user may choose to review the investigation results obtained from the users with higher user reputation scores than other users. In another example, the information related to the security indicator may inform the user that the security indicator has a high level of priority that requires immediate attention. In another example, when the total number of investigation results that have been obtained is low, the user may feel inclined to investigate the particular security indicator.

In block 522, method 500 may include obtaining an investigation result from the user. This new investigation result submitted by the user may indicate whether the security indicator is malicious (or has been misclassified as malicious and therefore is a false-positive). The investigation result may further include a comment (e.g., a reason that the security indicator is malicious or not malicious) and/or supporting evidence (e.g., attachments) obtained from the user.

In block 523, method 600 may include updating the indicator score based on the investigation result, When the new investigation result is obtained and added to the community-based threat information for the security indicator. At least one parameter that may be used to determine and/or update the indicator score may be also updated. The at least one parameter may include the number of the investigation results in the plurality of investigation results that indicate that the security indicator is malicious (or has been misclassified as malicious and therefore is a false-positive), the total number of the plurality of investigation results, the information related to the plurality of users, the information related to the security indicator, and/or other parameters. For example, the total number of the plurality of investigation results may be increased by one. The number of the investigation results in the plurality of investigation results that indicate the security indicator is malicious may also be increased by one if the user determined, in the new investigation result, that the security indicator is indeed malicious. The user score of the user of the new investigation result may influence the indicator score.

Referring back to FIG. 1, community information obtain engine 122 may be responsible for implementing block 521. Investigation result obtain engine 123 may be responsible for implementing block 522. Community information modify engine 124 may be responsible for implementing block 523.

FIG. 6 is a flow diagram depicting an example method 600 for sharing an event with another user. Method 600 as illustrated (and described in greater detail below) is meant be an example and, as such, should not be viewed as limiting. Method 600 may be implemented in the form of executable instructions stored on a machine-readable storage medium, such as storage medium 210, and/or in the form of electronic circuitry.

Method 600 may start in block 621 where community-based threat information associated with a security indicator is presented to a user via a user interface. Note that a “blacklist,” as used herein, may comprise a plurality of security indicators (e.g., a list of IP addresses, domain names, e-mail addresses, Uniform Resource Locators (URLs), software file hashes, etc.). For example, the blacklist may be used to block, filter out, and/or deny access to certain resources by an event that matches at least one of the plurality of security indicators and/or to generate a security alert when the match is detected. In some implementations, the blacklist may be shared with various users of a community or communities such that the users may collaboratively investigate individual security indicators of the blacklist using the community-based threat information associated with the individual security indicators.

The community-based threat information may comprise investigation results that are obtained from a community of users for the security indicator, an indicator score that is determined based on the investigation results, information related to the plurality of users (e.g., user identification, user scores, etc.), information related to the security indicator (e.g., an investigation status of the security indicator, a source of the security indicator, a level of severity, importance, priority, and confidence of the security indicator, historical sightings of the security indicator, etc.), and/or other information. The user can review the community-based threat information via the user interface to understand the contextual information about the security indicator before determining whether the security indicator is malicious (or has been misclassified as malicious and therefore is a false-positive). For example, the user may review at least one investigation result obtained from another user. The user may choose to review the investigation results obtained from the users with higher user reputation scores than other users. In another example, the information related to the security indicator may inform the user that the security indicator has a high level of priority that requires immediate attention. In another example, when the total number of investigation results that have been obtained is low, the user may feel inclined to investigate the particular security indicator.

In block 622, method 600 may include receiving, via the user interface, an indication that the security indicator is under investigation by the user. When the user is ready to investigate the security indicator, the user may indicate, via the user interface, that the security indicator is under the investigation by the user (e.g., by cricking on a graphical user interface (GUI) object).

In block 623, the investigation status may be updated and/or modified based on that indication such that the community-based threat information shows that the security indicator is under investigation by the particular user. When the user submits the new investigation result, the investigation status may be updated and/or modified to reflect that the investigation by the user has been completed. In this example, the investigation status may be time-stamped with a start time and/or an end time of the investigation.

In block 624, method 600 may include obtaining an investigation result from the user. This new investigation result submitted by the user may indicate whether the security indicator is malicious (or has been misclassified as malicious and therefore is a false-positive). The investigation result may further include a comment (e.g., a reason that the security indicator is malicious or not malicious) and/or supporting evidence (e.g., attachments) obtained from the user. The investigation result may be added to the community-based threat information (block 625).

In block 626, method 600 may include updating the indicator score based on at least one parameter (e, the number of the investigation results in the plurality of investigation results that indicate that the security indicator is malicious (or has been misclassified as malicious and therefore is a false-positive), the total number of the plurality of investigation results, the information related to the plurality of users, the information related to the security indicator, and/or other parameters). The values of the at least one parameter may be updated as the community-based threat information is updated based on the new investigation result. For example, the total number of the plurality of investigation results may be increased by one. The number of the investigation results in the plurality of investigation results that indicate the security indicator is malicious may also be increased by one if the user determined, in the new investigation result, that the security indicator is indeed malicious. The user score of the user of the new investigation result may influence the indicator score.

Referring back to FIG. 1, community information obtain engine 122 may be responsible for implementing block 621. Investigation result obtain engine 123 may be responsible for implementing blocks 622 and 624. Community information modify engine 124 may be responsible for implementing blocks 623 and 625-626.

The foregoing disclosure describes a number of example implementations for collaborative investigation of security indicators. The disclosed examples may include systems, devices, computer-readable storage media, and methods for collaborative investigation of security indicators. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-6 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for collaborative investigation of security indicators, the method comprising:
presenting, via a user interface, community-based threat information associated with a security indicator to a user, the community-based threat information comprising investigation results that are obtained from a community of users for the security indicator, and an indicator score that is determined based on the investigation results;
obtaining an investigation result from the user; and
updating the indicator score based on the investigation result.

2. The method of claim 1, wherein the community-based threat information comprises information related to the community of users and information related to the security indicator.

3. The method of claim 2, further comprising:
receiving, via the user interface, an indication that the security indicator is under investigation by the user; and
updating the investigation status based on the indication that the security indicator is under investigation by the user.

4. The method of claim 1, further comprising:
detecting when event data includes an event that matches at least one security indicator of a blacklist; and
generating a security alert based on the detection.

5. The method of claim 4, further comprising:
determining whether to remove the security indicator from the blacklist based on the indicator score.

6. The method of claim 4, further comprising:
adding the investigation result to the community-based threat information; and
updating the indicator score based on at least one parameter, the at least one parameter comprising the total number of the investigation results, the number of the investigation results indicating that the security indicator is malicious, information related to the community of users, and information related to the security indicator.

7. A non-transitory machine-readable storage medium comprising instructions executable by a processor of a computing device for collaborative investigation of security indicators, the machine-readable storage medium comprising:
instructions to cause a display of community-based threat information associated with a security indicator, the community-based threat information comprising a collaborative set of investigation results that is obtained from a plurality of users for the security indicator and an indicator score;
instructions to obtain an investigation result indicating whether the security indicator is malicious;
instructions to include the investigation result in the collaborative set; and
instructions to determine the indicator score based on at least one parameter, the at least one parameter comprising the number of the investigation results in the collaborative set that indicate that the security indicator is malicious.

8. The non-transitory machine-readable storage medium of claim 7, wherein the at least one parameter comprises the total number of the investigation results in the collaborative set, information related to the plurality of users, and information related to the security indicator.

9. The non-transitory machine-readable storage medium of claim 7, further comprising:
instructions to determine whether event data includes an event that corresponds to the security indicator of a blacklist; and
in response to determining that the event data includes the event that corresponds to the security indicator of the blacklist, instructions to generate a security alert.

10. The non-transitory machine-readable storage medium of claim 7, further comprising:
instructions to compare the indicator score with a threshold; and
instructions to exclude the security indicator from a blacklist based on the comparison.

11. The non-transitory machine-readable storage medium of claim 7, further comprising:
instructions to compare the total number of the investigation results in the collaborative set with a threshold; and
instructions to exclude the security indicator from a blacklist based on the comparison.

12. A system for collaborative investigation of security indicators comprising:
a processor that:
generates a security alert based on a detection of a security indicator in event data, wherein a blacklist comprises a plurality of security indicators;
in response to the security alert, obtains community-based threat information associated with the security indicator, the community-based threat information comprising a plurality of investigation results that are obtained from a plurality of users for the security indicator and an indicator score that is determined based on the plurality of investigation results;
obtains a new investigation result from a user, the new investigation result indicating whether the security indicator is malicious;
modifies the indicator score based on the new investigation result; and
determines whether to remove the security indicator from the blacklist based on the indicator score.

13. The system of claim 12, the processor that:
determines the indicator score based on at least one parameter, the at least one parameter comprising the total number of the plurality of investigation results, the number of the investigation results in the plurality of investigation results that indicate that the security indicator is malicious, information related to the community of users, and information related to the security indicator.

14. The system of claim 12, the processor that:
determines whether a change to the community-based threat information occurs; and
in response to determining that the change to the community-based threat information occurs, generates a notification that informs at least one of the plurality of users of the change.

15. The system of claim 12, the processor that:
determines a user score associated with the user based on at least one investigation result that the user has previously submitted; and
determines the indicator score based on the user score.
